(19) United States
(12) Patent Application Publication
(10) Pub. No.: US 2006/0040694 A1
(43) Pub. Date: Feb. 23, 2006

(54) Method of communication using push to talk scheme in mobile communication system

(75) Inventors: Sung-Jae Yoon, Gumi-si (KR); Dong-Han Kang, Dalseo-gu (KR); Jae-Gwan Shin, Suseong-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/203,220

(22) Filed: Aug. 15, 2005

(30) Foreign Application Priority Data
Aug. 19, 2004 (KR) 2004-65345

(51) Int. Cl. H04B 7/00; H04Q 7/20

(52) U.S. Cl. 455/519; 455/512

(57) ABSTRACT

Disclosed is a method for communication using a Push To Talk (PTT) call traffic scheme in a mobile communication system including the steps of selecting, by a calling mobile communication terminal, at least one subscriber with whom the calling user wants to communicate through the PTT call traffic scheme, and selecting one of a plurality of predetermined importance levels of a PTT call request message; transmitting the PTT call request message having the selected one importance level from the calling communication terminal to the selected subscriber's mobile communication terminal via a PTT server; confirming the one importance level included in the PTT call request message which the called mobile communication terminal has received; and providing, by the called mobile communication terminal, a predetermined alarm message indicating a reception of the PTT call request message in response to the confirmed one of the importance levels of the PTT call request message.

### PRIORITY

This application claims to the benefit under 35 U.S.C. §119(a) of an application entitled “METHOD OF COMMUNICATION USING PUSH TO TALK SCHEME IN MOBILE COMMUNICATION SYSTEM” filed in the Korean Industrial Property Office on Aug. 19, 2004 and assigned Ser. No. 2004-65345, the entire contents of which are hereby incorporated by reference.

### BACKGROUND OF THE INVENTION

1. Field of the Invention

The present invention relates to a mobile communication system using a Push To Talk (PTT) scheme. More particularly, the present invention relates to a method for connecting call traffic in the PTT mobile communication terminal.

2. Description of the Related Art

The PTT is referred to as “a basic call traffic scheme” used for a walkie-talkie or Handheld Transceiver (HT). The PTT scheme allows a user to communicate with her/his counterpart by properly operating PTT buttons disposed on, for example, a walkie-talkie. Specifically, during communications based on the PTT scheme, the user simply presses the PTT button when talking to her/his counterpart, and releases the pressed PTT button when listening to her/his counterpart's spoken response. Such a PTT scheme provides one-to-one or one-to-multi party communication through which the users can simply and rapidly communicate with each other.

In recent years, conventional mobile communication systems have provided so called internet phone service of Voice over IP (VoIP) scheme in which a specific Internet Protocol (IP) has been previously assigned to each of the terminals of the system. Similar to the walkie-talkie or HT, such a VoIP scheme can also allow the mobile communication terminals to communicate with each other in the form of mobile communication PTT service, which is capable of providing one-to-one or one-to-multi communication.

Such a mobile communication PTT service can provide voice data services through which multipleusers or groups can communicate simultaneously with each other. In order to start the mobile communication PTT service, the user presses a PTT button disposed on the mobile communication terminal capable of providing the PTT service so that the PTT mobile communication terminal may send a PTT service request to a mobile communication network related therewith. Then, the mobile communication network denies or accepts the requested service to, in case of the acceptance, assign the requested resources based on the determination criteria such as the availability of resources, the priority of the requesting user, and the like. If the requested service has been accepted, the mobile communication network sets up connections among all the active users belonging to a certain user group. Consequently, the called mobile communication terminal outputs an alarm sound and displays message indicating the receipt of a PTT call request to the corresponding called user who, then, recognizes the PTT call request, and starts communicating either by voice or by transferring data with the calling user. After setting up a voice traffic connection, the user who has requested voice service can send the voice information to the corresponding user who then can hear the voice information just sent.

As mentioned above, in such a mobile communication PTT service, the called mobile communication terminal provides the alarm sound and the alarm message displays for notifying the received PTT call request to the corresponding user. The alarm messages can include an ID identifier, phone number of the calling user, or other suitable information. Therefore, the called user recognizes the identity of the calling user based on the displayed alarm messages to determine if she/he will accept the requested PTT call.

The user who is communicating with her/his counterpart under PTT service may often have to urgently or more importantly communicate with a third party through the PPT communication. In the prior art, however, as mentioned above, the alarm function for indicating the reception of the PTT call request merely allows the called user to recognize only the identity of the calling user. The called user does not know exactly the importance level of the requested PTT call. Accordingly it is difficult for the called user to conveniently or easily decide to respond to the requested PTT call because of insufficient information provided by the conventional PTT communication service.

### SUMMARY OF THE INVENTION

Accordingly, the present invention has been made to solve the above-mentioned problems occurring in the prior art, and an object of the present invention is to provide a method for connecting call traffic based on Push To Talk (PTT) scheme in a mobile communication system in which a called user can easily and conveniently decide to respond to the requested call.

Another object of the present invention is to provide a method for connecting call traffic based on Push To Talk (PTT) scheme in a mobile communication system in which a called user can recognize the importance of the requested call when a calling user sends the call request message to the called user.

In order to accomplish this object, according to one aspect of the present invention, there is provided a method for communication using a Push To Talk (PTT) call traffic scheme in a mobile communication system, the method comprises the steps of selecting, by a calling mobile communication terminal, at least one subscriber with whom the calling user wants to communicate through the PTT call traffic scheme, and selecting one of a plurality of predetermined importance levels of a PTT call request message; transmitting the PTT call request message having the selected one importance level from the calling communication terminal to the selected subscriber's mobile communication terminal or a called mobile communication terminal via a PTT server; confirming the one importance level included in the PTT call request message which the called mobile communication terminal has received; and providing, by the called mobile communication terminal, a predetermined alarm message indicating a reception of the PTT call request message in response to the confirmed one of the importance levels of the PTT call request message.

### BRIEF DESCRIPTION OF THE DRAWINGS

The above and other objects, features and advantages of the embodiments of the present invention will be more apparent from the following detailed description taken in conjunction with the accompanying drawings, in which:

FIG. 1 illustrates a schematic block structure of a mobile communication system using a Push To Talk (PTT) scheme according to an embodiment of the present invention;

FIG. 2A illustrates a schematic block structure of a PTT mobile communication terminal according to an embodiment of the present invention;

FIG. 2B illustrates an exterior structure of a PTT mobile communication terminal according to an embodiment of the present invention;

FIG. 3 illustrates a flow chart for explaining the operation process of a general PTT call traffic connection in the mobile communication system of FIG. 1.

FIG. 4 illustrates a flow chart for explaining the method for establishing a PTT call traffic connection in the PTT mobile communication system according to an embodiment of the present invention;

FIG. 5A illustrates an exemplary user interface display when performing the normal call traffic connection operation in a mobile communication terminal according to an embodiment of the present invention; and

FIG. 5B illustrates an exemplary user interface display when performing the urgent PTT call traffic connection operation in a mobile communication terminal according to an embodiment of the present invention.

It should be understood that like reference numbers refer to like features, structures, and elements.

### DETAILED DESCRIPTION OF EXEMPLARY EMBODIMENTS

Hereinafter, exemplary embodiments of the present invention will be described with reference to the accompanying drawings. It should be understood by those skilled in the art that various changes in form and details may be made therein without departing from the spirit and scope of the invention.

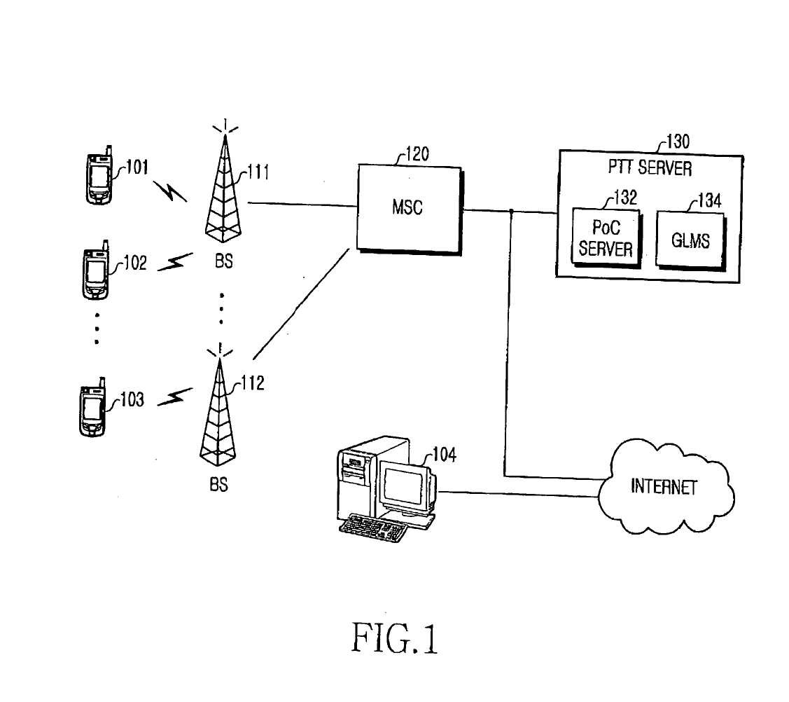

FIG. 1 illustrates a schematic block structure of a mobile communication system using a Push To Talk (PTT) scheme according to an embodiment of the present invention. Referring to FIG. 1, the mobile communication system using the PTT scheme includes generally a plurality of base station transceiver systems (BTSs) 111 and 112 which communicate with a plurality of mobile communication terminals 101, 102 and 103 located in the service coverage area of the BTSs to provide the mobile communication services. The plurality of base station transceiver systems (BTSs) 111 and 112 are connected to a mobile switching center (MSC) 120 which preferably is connected to a PTT server 130 via a data network.

The PTT server 130 preferably performs realtime management operation for PTT user groups including managing the general control operations for PTT user groups, mediating and holding of PTT communication requests, distributing the subscriber registration lists and call setups and separations of needed systems and network resources. Such a PTT server 130 preferably comprises a PTT over Cellular (PoC) server 132 for performing a communication function for the PTT service in the mobile communication network, and a Group and List Management Server (GLMS) 134 for managing PTT subscribers' information and subscriber group list (called also as “buddy list”).

Each of the mobile communication terminals 101, 102 and 103 preferably comprises a PTT module for performing PTT-related operations such as a PTT call request transferred to the PTT server 130 to wirelessly send the PTT call request in the form of a previously and properly set format to the BTSs 111 and 112 when operating the PTT call traffic. The MSC 120 receives the PTT call request from the BTSs 111 and 112 and provides the received PTT call request to the PTT server 130. The MSC 120 has an Inter Working Function (IWF) for processing certain data packets including such a PTT call request with the PTT server 130.

The users can connect their mobile communication terminals 101, 102 and 103 to the PTT server 130 to perform modification operations such as newly establishing, changing or deleting the group list information and the individual information which have been previously set up by just the users. Alternatively, the user can connect their personal computer 104 to the PTT server 130 via the Internet or other suitable network to also modify the group list information and the individual information which have been previously set up by just the user.

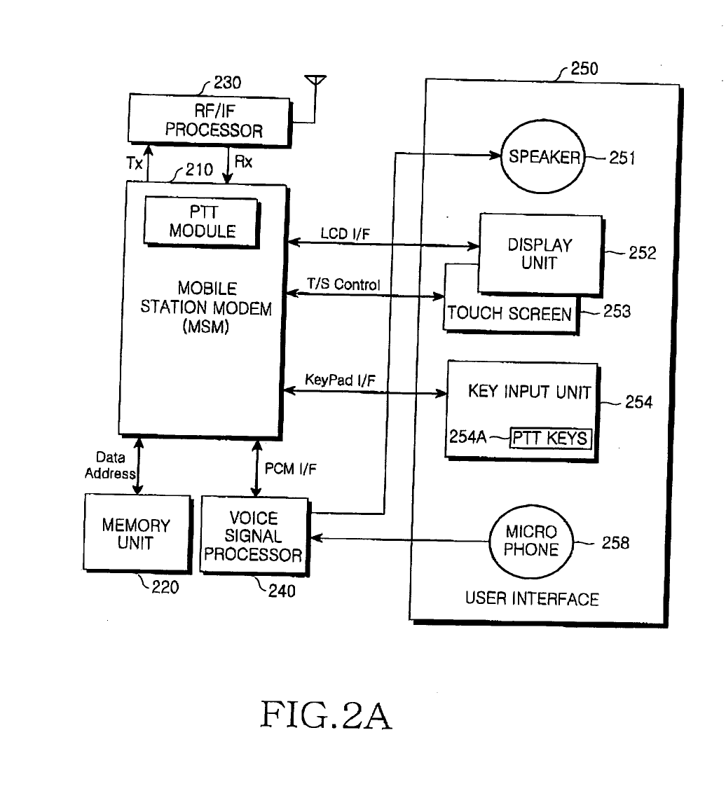

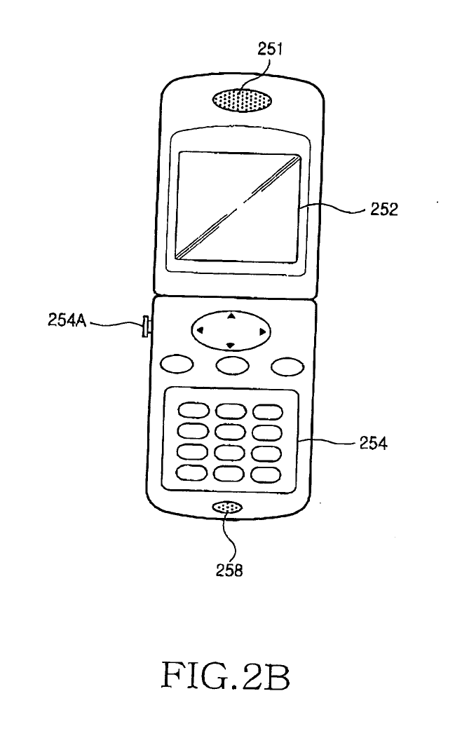

FIG. 2A illustrates a schematic block structure of a PTT mobile communication terminal according to an embodiment of the present invention, and FIG. 2B illustrates an exterior structure of a PTT mobile communication terminal according to an embodiment of the present invention. Referring to FIGS. 2A and 2B, the mobile communication terminal using the principles of the embodiments of the present invention is capable of receiving inputs from a user through a user interface. The mobile communication terminal comprises a user interface 250, an RF/IF processor 230 for processing radio signals, a memory unit 220 preferably having ROM and RAM for storing various operation programs and operation-related data, a voice signal processor (CODEC) 240 for processing voice signals and a mobile station modem (MSM) 210 for taking a modem role as well as the role of a central processing unit for controlling the overall operation of a mobile communication terminal. The user interface preferably 250 has a speaker 251, a display unit 252, which is preferably a liquid crystal display (LCD)), a key input unit 254 and a microphone 258.

Hereinafter, the operation of each functional unit of the mobile communication terminal implemented as embodiments of the present invention will now be described. First, in the user interface 250, the microphone 258 converts the user's voice into an electrical signal to send the electrical signal to the voice signal processor (CODEC) 240. Conversely, the speaker 251 receives the electrical signal from the voice signal processor 240 and generates an audible sound based on the received electric signals. The key input unit 254 of the user interface 250 preferably includes a plurality of numeric and character keys for inputting numbers and characters, a plurality of function keys for performing the mobile communication functions, and dedicated PTT keys 254A for performing the PTT functions. Such a key input unit 254 transfers key input data to the mobile station modem 210 when the user inputs the related certain data or information through the keys of the key input unit 254. Although the dedicated PTT keys 254A are disposed in a separate form from the other keys on the key input unit 254 as shown in FIG. 2A, the PTT keys may be implemented by using a part of the known or conventional keys. The display unit 252, which is preferably an LCD that includes generally an LCD controller, a memory for storing image data and LCD display elements. The display unit 252 displays characters or number information such as a current condition of the mobile communication terminal or background images related therewith. The display unit 252 may have a touch screen 253 for an LCD.

The RF/IF processor 230 preferably comprises an RF transmitter for up-converting frequencies of the signals to be transmitted and amplifying the signals, and an RF receiver for low-noise amplifying received signals and down-converting the frequencies of the received signals. The RF/IF processor 230 receives modulated signals from the mobile station modem 210 and converts the modulated signals into intermediate frequencies (IF). Also, the RF/IF processor 230 converts the intermediate frequencies into radio frequencies (RF) to be output to the BTSs via the antenna. Furthermore, the RF/IF processor 230 receives the radio signals from the BTSs via an antenna so that the received radio signals are converted sequentially into the intermediate frequencies and the baseband to be provided to the mobile station modem 210.

The voice signal processor 240, which is typically formed of audio CODEC, receives analog voice signals from the microphone 258 to convert the received analog voice signals into digital signals that are preferably pulse code modulated (PCM) signals, which are transmitted to the mobile station modem 210. Also, the voice signal processor 240 receives the PCM digital signals of a counterpart's voice from the mobile station modem 210 to convert the received digital signals to analog signals to be output to the speaker 251. Although the voice signal processor 240 is designed in the separate form as shown in FIG. 2A, the voice signal processor 240 may be embedded integrally in the mobile station modem 210 so that the voice signal processor 240 and the mobile station modem 210 may be combined together in the form of one chip.

The mobile station modem 210 can perform various functions for the mobile communication terminal in accordance with the key data input through the key input unit 254, while the various information such as the current states and user menu may be displayed on the display unit based on the functions performed. Particularly, in the case of processing the voice signals for phone traffic, the mobile station modem 210 receives the PCM voice signals from the voice signal processor 240, and converts and modulates the received PCM voice signals by channel coding and interleaving to provide the converted and modulated signals to the RF/IF processor 230. Further, the mobile station modem 210 receives the voice signals provided from the RF/IF processor 230 and processes the received voice signals through demodulating, equalizing, channel decoding and de-interleaving to generate the resultant PCM voice signals that are then sent to the voice signal processor 240. Furthermore, the mobile station modem 210 has a PTT module for performing the PTT call traffic operation, especially for a certain user, such as one-to-one call traffic operation among the PTT group call traffic, in accordance with the characteristics of embodiments of the present invention.

In the operation of the mobile communication terminal shown in FIG. 2A and 2B, if the user performs a dialing operation and a setting operation for a calling mode through the key input unit 254, then the mobile station modem 210 monitors those operations and processes the input dialing information to then convert the input dialing information into corresponding radio signals through the RF/IF processor 230 to be output. Next, response signals are received from the counterpart's terminal via the RF/IF processor 230 in the mobile station modem 210 so that the received response signals may be output to the speaker 251 via the voice signal processor 240 to consequently form a voice traffic path for communication. In the case of the called mode, the mobile station modem 210 monitors just the called mode through the RF/IF processor 230, and directs the voice signal processor 240 to generate the corresponding ring signals. Next, similar to the calling mode, when the counterpart sends response signals, the mobile station modem 210 monitors the response signals which may be output to the speaker 251 via the voice signal processor 240 to consequently form a voice traffic path for communication. As mentioned above, only the exemplary voice communication was described for both the calling and the called modes according to an embodiment of the present invention. However, alternatively, data communication functions for packet data and image data and the PTT communication operation based on PTT key inputs also can be applied to the embodiments of the present invention.

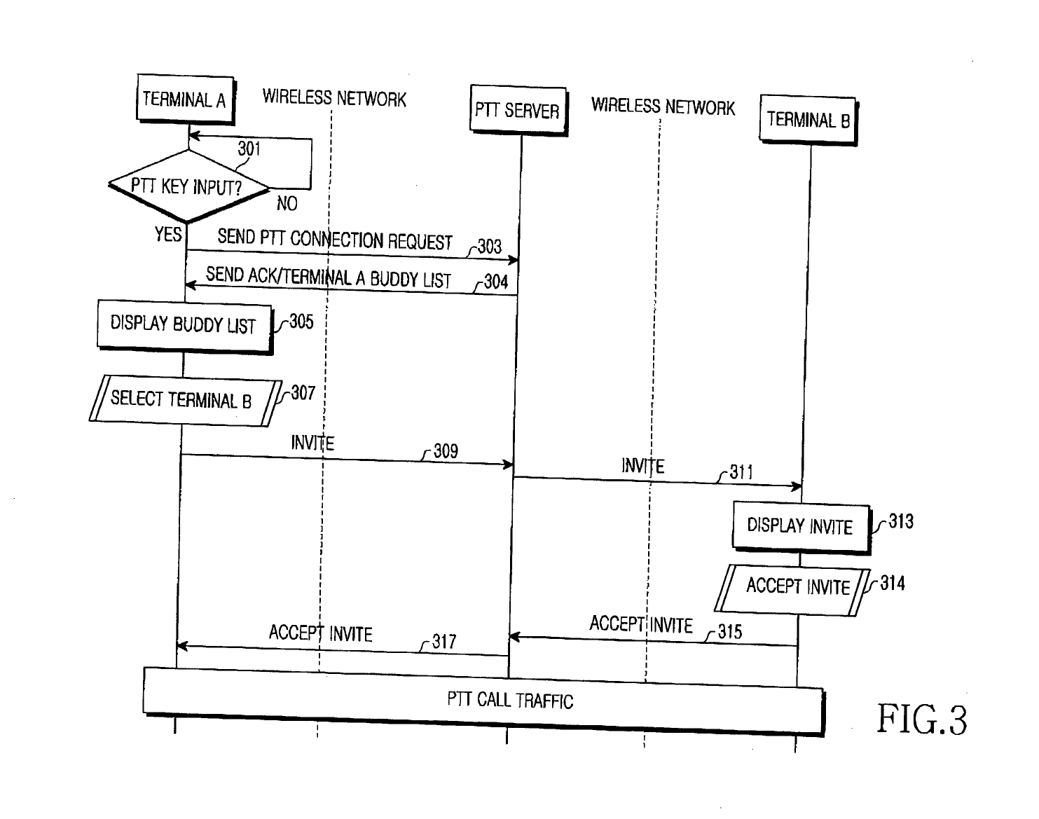

FIG. 3 illustrates a flow chart for explaining the process for making a general PTT call traffic connection in the mobile communication system of FIG. 1. Referring to FIG. 3, firstly, if the user who wants the PTT communication inputs the PTT keys disposed on a mobile communication terminal (terminal A in FIG. 3) or operates PTT call functions through a menu setting operation, then in step 301, the mobile station modem confirms that there is a PTT key input or an operation of the PTT call functions to drive the PTT application.I In step 303, the mobile station modem sends the PTT connection request message to the PTT server via the wireless network. If the PTT server confirms the corresponding user who has previously sent the PTT connection request message through the GLMS server, then in step 304, the PTT server acknowledges the PTT connection request of the corresponding user and sends a buddy list, which is subscriber information of the terminal A PTT call traffic group, to the corresponding user preferably by sending an acknowledgement (ACK)/terminal A buddy list. Accordingly, the mobile station modem of the terminal A receives the buddy list so that the display unit may properly display the buddy list in step 305. Referring to the displayed buddy list, the user of the terminal A can operate proper direction keys to select her/his counterpart who the user wants to communicate with through the PTT scheme. Specifically, in step 307, the mobile communication terminal, terminal A, inputs the selected counterpart or the selected subscriber (in case of FIG. 3, terminal B) by the user's operation. Next, in step 309, the mobile communication terminal, terminal A, sends a PTT call request message (referred to as an “INVITE”) for the selected subscriber, which is terminal B, to the PTT server via the wireless network. Such a PTT call request message (INVITE) preferably includes, for example, an ID information of the calling or called side.

Hereinafter, a description will be made in more detail of the step where the mobile communication terminal (terminal A) sends the PTT call request (INVITE) to the PTT server. Above all, the mobile communication terminal, terminal A sends the PTT call request message (INVITE) in the form of Short Data Burst (SDB) to the base station to which the terminal A is connected. Then, the mobile communication terminal, terminal A, negotiates with the base station for service option (SO_PTT) to provide the PTT service, and performs Traffic Channel (TCH) setup. The term “negotiates” means the process for preparing for higher network sessions, which range from physical layers including the PPP session to the application layers.

After this, the base station forwards the PTT call request message (INVITE) received from terminal A to the PTT server which then confirms the ID of the called side based on the received message (INVITE). Next, in step 311, the PTT server sends the PTT call request message (INVITE) to the called mobile communication terminal (terminal B). The called mobile communication terminal (terminal B) receives the PTT call request message (INVITE), and in step 313, informs the terminal B user of the reception of the PTT call request message (INVITE) by preferably sounding the proper alarm sound and or displaying the proper alarm message.

Steps 311 and 313 will now be described in more detail. The PTT server sends the PTT call request message (INVITE) to a corresponding base station, which provides the services to the called mobile communication terminal (terminal B). The corresponding base station for the called mobile communication terminal periodically sends a paging signal (GP: General Page) to the called mobile communication terminal (terminal B) which then sends the corresponding response signal (PS: Page Response) for the GP to the corresponding base station. During such a paging process, the base station sends the PTT call request message (INVITE) in the form of SDB to the called mobile communication terminal (terminal B). Then, the called mobile communication terminal (terminal B) informs the called user of the reception of the PTT call request message (INVITE) to the called user. At the same time, the called mobile communication terminal (terminal B) sends acknowledgement of the normal reception of the PTT call request message (INVITE) to the base station.

By the way, if the called user has recognized the reception of the PTT call request message (INVITE) in step 313, the called user can allow or accept the corresponding PTT call request by operating the proper keys such that, in step 314, the called mobile communication terminal (terminal B) can receive the key inputs for accepting the PTT call request. The called mobile communication terminal (terminal B), in step 315, can send the PTT call request acceptance message to the PTT server via the wireless network. In step 317, the PTT server forwards just the PTT call request acceptance to the calling mobile communication terminal (terminal A) to allow communication through the PTT call traffic.

Steps 315 and 317 will now be described in more detail. When sending the PTT call request acceptance, the called mobile communication terminal (terminal B) sends the PTT call request acceptance message (so called “200 OK”) in the form of SDB to a corresponding base station. Then, the called mobile communication terminal (terminal B) negotiates with the corresponding base station for a service option (SO_PTT) to provide the PTT service, and performs a Traffic Channel (TCH) setup. The PTT call request acceptance message (200 OK) that originated in the called mobile communication terminal (terminal B) is transferred finally to the calling mobile communication terminal (terminal A) via the base station of the called side, the PTT server and the base station of the calling side. The calling mobile communication terminal (terminal A) receives the PTT call request acceptance message to complete the traffic channel setup. Also, the calling mobile communication terminal informs terminal user of the PTT call request acceptance by preferably displaying the alarm message through the display unit.

After this, in the PTT call traffic between the calling and the called mobile communication terminals, a specific terminal (for example, terminal A) sends a speaking right request message referred to as “Session Initiation Protocol (SIP) Ack” to the PTT server. Then, the PTT server controls the speaking permission requests between the terminals to grant speaking permission to a proper mobile communication terminal. The mobile communication terminal, which has obtained the speaking right transmits, in realtime, the talk burst to the PTT server through a Real Time Protocol (RTP). The PTT server firstly buffers the talk burst to transmit the buffered talk burst to the called mobile communication terminal through the RTP.

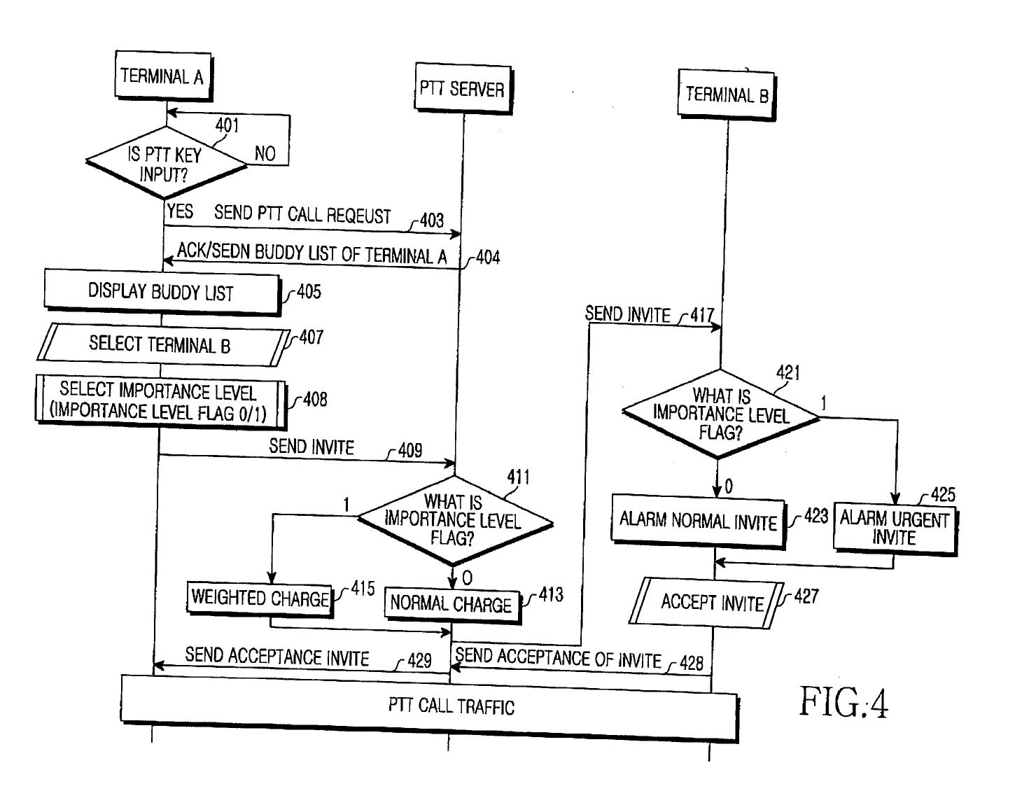

FIG. 4 illustrates a flow chart for explaining the method for establishing a PTT call traffic connection in the PTT mobile communication system according to an embodiment of the present invention. Referring to FIG. 4, if the user who wants the PTT communication inputs PTT keys disposed on a mobile communication terminal (terminal A) or operates the PTT call function through a menu setup operations, the mobile communication terminal (A terminal) monitors the input PTT keys or the menu setup operations to drive the corresponding applications in step 401, and to send the PTT connection request message to the PTT server via the wireless network in step 403. The PTT server receives the PTT connection request message to acknowledge (ACK) the received request and sends a buddy list of the corresponding user in step 404. Next the mobile communication terminal (terminal A) receives the buddy list to properly display the received buddy list through the display unit 252. Therefore, preferably through the operation of the direction keys, the user of the mobile communication terminal (terminal A) can select a subscriber to whom the user wants to connect the PTT communication based on the displayed buddy list. Specifically, in step 407, the mobile communication terminal (terminal A) inputs such keys to select the desired subscriber's terminal (terminal B).

Before sending the PTT call request message (INVITE) to the selected subscriber's mobile communication terminal (terminal B), the mobile communication terminal A may set up or select the importance level of the requested call message in step 408 according to an embodiment of the present invention. For example, the importance of the PTT call request message (INVITE) may include ‘normal’ and ‘urgent’. And the setup or selection of the importance level may be performed automatically through the previously and properly prepared environment configuration setup menu for PTT operation when the called subscriber is selected, or performed through the input of a so called ‘menu key’ when the PTT call request message is transmitted. When the setup operation of the importance level is performed, a separate window for representing ‘normal/urgent’ menu items may preferably be displayed such that the user can operate or manipulate direction keys or confirmation keys to select one of the importance level items.

As mentioned above, if the mobile communication terminal sets up the importance level of the requested PTT call request in step 408, then in step 409 the terminal sends the PTT call request message (INVITE) to the PTT server. In this case, the PTT call request message (INVITE) has an importance level flag indicating the importance level set by the user. The importance level flag is preferably located in the proper sector of the PTT call request message, and, for example, is one bit of which value may be ‘1’ or ‘0’ corresponding to ‘urgent’ or ‘normal’, respectively.

The PTT server checks the importance level flag contained in the PTT call request message. If the checked flag is ‘1’, the PTT server considers the importance level of the received PTT call request message (INVITE) as ‘urgent’, then the process goes to step 415. Whereas if the checked flag is ‘0’, the importance level corresponds to ‘normal’, and then the next process goes to step 413. In step 415, the PTT server makes a properly weighted charge bill for handling the corresponding PTT call request message (INVITE) having the urgent importance level. Whereas in step 413, the PTT server makes a normal charge bill for handling the corresponding PTT call request message (INVITE) having the normal importance level. Next, both steps 413 and 415 progress to step 417 wherein the PTT server sends the PTT call request message (INVITE) to the called mobile communication terminal (terminal B). The PTT server identifies the ID of the called mobile communication terminal from the PTT call request message (INVITE) to transfer the received PTT call request message (INVITE) to the called mobile communication terminal of the identified ID in step 417.

The called mobile communication terminal (terminal B) which has received the PTT call request message (INVITE) indicates the receipt of the PTT call request to its user by outputting an alarm sound and displaying the alarm message. Prior to indicating the reception of the PTT call request to its user, however, the called mobile communication terminal (terminal B) checks the importance level of the received PTT call request. If the checked flag is ‘1’, the mobile communication terminal (terminal B) considers the importance level of the received PTT call request message (INVITE) as ‘urgent’, then the process goes to step 425. Whereas if the checked flag is ‘0’, the importance level corresponds to ‘normal’, and then the next process goes to step 423. In step 425, the mobile communication terminal (terminal B) notifies its user that the received call request message (INVITE) is urgent by causing the output of a properly predetermined alarm sound or displaying the alarm message. In step 423, the mobile communication terminal (terminal B) notifies its user that the received call request message (INVITE) is normal by the same manner as in the step 425.

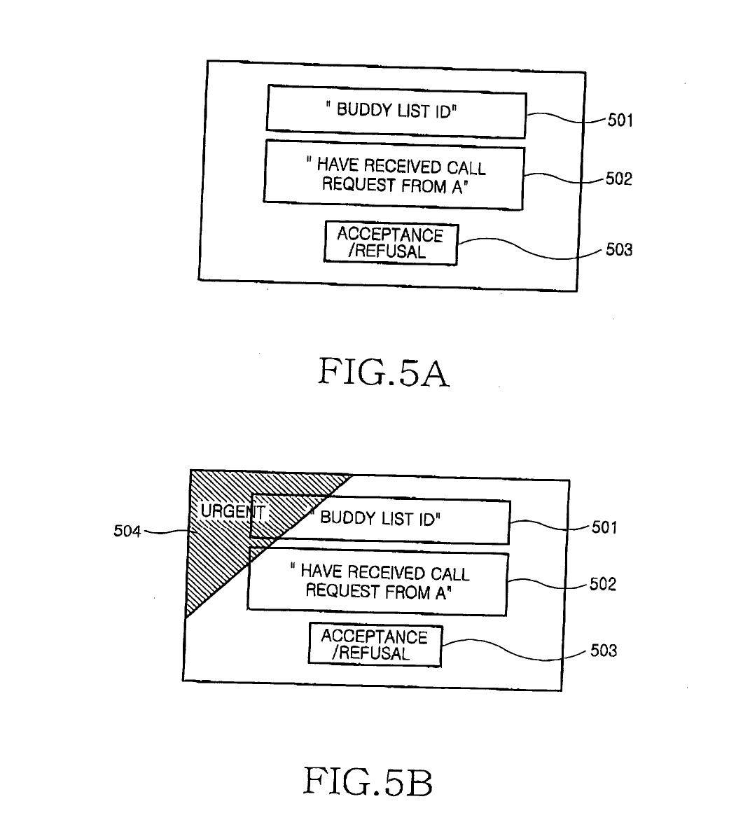

FIG. 5B illustrates an exemplary user interface screen when performing the urgent PTT call traffic connection operation in a mobile communication terminal according to an embodiment of the present invention. Referring to FIG. 5B, the displays of the user interface may include for example, a buddy list ID output window 501 for displaying the buddy list ID of the calling user who has sent the corresponding PTT call request message (INVITE), an information output window 502 for informing that the received request is just the PTT call request message (INVITE), a selection icon 603 for acceptance (conversation)/refusal menu and further a properly colored urgent alarm icon 504 for notifying the urgent call request. Such an urgent alarm icon 504 may be displayed by blinking. Whereas, FIG. 5A illustrates an exemplary user interface screen when the normal call request message (INVITE) is received. Referring to FIG. 5A, the screen of the user interface includes only a buddy list ID output window 501 for displaying the buddy list ID of the calling user who has sent the corresponding PTT call request message (INVITE), an information output window 502 for informing that the received request is just the PTT call request message (INVITE), and a selection icon 603 for acceptance (conversation) /refusal menu without the urgent alarm icon 504 which only the user interface of FIG. 5B has.

Accordingly, the user who has recognized the reception of the PTT call request message (INVITE) data through step 417 can accept the PTT call request by operating or manipulating the proper keys. Specifically, in step 427, the user of the called mobile communication terminal (terminal A) accepts the call request or requested conversation by operating or manipulating the proper keys. Next, in step 428 the called terminal (terminal B) sends the PTT call request acceptance message to the PTT server. Consequently, in step 429, the PTT server forwards the PTT call request acceptance message to the calling mobile communication terminal (terminal A) to accomplish the PTT communication between the mobile communication terminals (terminals A and B).

As mentioned above, the PTT call traffic operation may be performed in the mobile communication system according to an embodiment of the present invention. While the invention has been shown and described with reference to exemplary embodiments thereof, it will be understood by those skilled in the art that various changes and modifications in form and details may be made therein without departing from the spirit and scope of the invention. For example, in the above embodiments, the importance level flag has one bit for indicating two steps, that is, ‘urgent/normal’. However, the importance level flag may have more than two bits for allowing more than two steps to be set up. Of course, in this case, the PTT server may classify properly charge grades and provide several alarm steps of the PTT call request message (INVITE) based on the classified steps of the importance levels. Accordingly, the scope of the embodiments of the present invention should be defined by the appended claims and its equivalent.

According to embodiments of the present invention, in the PTT call traffic operation, the calling mobile communication terminal can select the importance level of its PTT call request message, while the called mobile communication terminal can provide an alarm message for indicating the importance level of the PTT call request message so that the called user may recognize the importance level of the PTT call request message to easily and conveniently decide whether she/he wants to accept the requested PTT call.

What is claimed is:

1. A method for communication using a Push To Talk (PTT) call traffic scheme in a mobile communication system, the method comprising the steps of:
selecting, by a calling mobile communication terminal, at least one subscriber with whom the calling user wants to communicate through the PTT call traffic scheme, and selecting one of a plurality of predetermined importance levels of a PTT call request message;
transmitting the PTT call request message having the selected one importance level from the calling communication terminal to a called mobile communication terminal via a PTT server, wherein the called mobile communication terminal is the selected subscriber's mobile communication terminal;
confirming the one importance level included in the PTT call request message which the called mobile communication terminal has received; and
providing, by the called mobile communication terminal, a predetermined alarm message indicating a reception of the PTT call request message in response to the confirmed one of the importance levels of the PTT call request message.

2. The method as claimed in claim 1, wherein the step of selecting one of the predetermined importance levels of the PTT call request message comprises setting up predetermined user interfaces which provide the importance level selection items when the PTT call request message is transmitted.

3. The method as claimed in claim 1, wherein when transmitting the PTT call request message from the calling mobile communication terminal to the called mobile communication terminal, the PTT server confirms the selected importance level included in the PTT call request message to make a properly weighted charge bill based on the confirmed importance level.

4. The method as claimed in claim 1, wherein the plurality of predetermined importance levels comprises two different levels.

5. The method as claimed in claim 4, wherein the two different predetermined importance levels comprise a normal level and an urgent level, wherein when the urgent importance level is selected, the called mobile communication terminal provides the predetermined alarm message including an predetermined alarm sound and a predetermined display for indicating the reception of the PTT call request message, and the display further having a predetermined colored icon for indicating the urgent importance level.

6. A method for communication using a Push To Talk (PTT) call traffic scheme in mobile communication terminals of a mobile communication system, the method comprising the steps of:
confirming one of a plurality of predetermined importance levels included a PTT call request message which a called mobile communication terminal has received from a calling mobile communication terminal via a PTT server, the calling mobile communication terminal having selected the one of the predetermined importance levels; and
selecting and providing, by the called mobile communication terminal, one of a plurality of predetermined alarm messages indicating a reception of the PTT call request message according to the confirmed one of the importance levels of the PTT call request message.

7. The method as claimed in claim 6, wherein the plurality of importance of levels comprise a normal level and an urgent level, wherein when the importance level is set to the ‘urgent’ level the selected one of the plurality of predetermined alarm messages includes an predetermined alarm sound and a predetermined display for indicating the reception of the PTT call request message, and the display further having a predetermined colored icon for indicating the urgent importance level.

8. A mobile communication terminal for communication with another mobile communication terminal comprising:
a selecting means for selecting at least one subscriber with whom the calling user wants to communicate with through the Push-to-Talk (PTT) call traffic scheme, and selecting one of a plurality of predetermined importance levels of a PTT call request message;
a transmitting means for transmitting a PTT call request message having the selected one importance level to a PTT server;
a receiving means for receiving a PTT call request message from a PTT server; and
an indicating means that provides a predetermined alarm message indicating a reception of the PTT call request message in response to the selected one of the importance levels of the PTT call request message.

9. The mobile communication terminal of claim 9, wherein the predetermined alarm message comprises a predetermined alarm sound and a predetermined display for indicating the reception of the PTT call request message, and the display further having a predetermined colored icon for indicating the urgent importance level.

10. A Push-To-Talk (PTT) server for establishing a PTT connection between mobile communication terminals comprising:
a receiving means for receiving connection requests from a mobile communication terminal and for receiving invite requests when the user of a calling mobile communication terminal has selected a user of a called mobile communication terminal on a buddy list to contact and the level of importance for the selected user;
a transmitting means for transmitting a connection acknowledgement and a buddy list to a mobile communication terminal in response to a connection request; and
a confirming means for confirming the selected importance level included in the invite message sent by mobile communication terminal, wherein when transmitting the PTT call request message from the calling mobile communication terminal to the called mobile communication terminal, the PTT server confirms the importance level included in the PTT call request message to make a properly weighted charge bill based on the confirmed importance level.
